(19) United States
(12) Patent Application Publication
(10) Pub. No.: US 2012/0234733 A1
(43) Pub. Date: Sep. 20, 2012

(54) DEVICE FOR FEEDING A PRODUCT, IN PARTICULAR AN INFUSION PRODUCT, TO A PACKAGING MACHINE

(75) Inventors: DARIO REA, MONTERENZIO (BOLOGNA) (IT); SAURO RIVOLA, RIOLO TERME (RAVENNA) (IT)

(73) Assignee: I.M.A. INDUSTRIA MACCHINE AUTOMATICHE S.P.A., OZZANO EMILIA (BOLOGNA) (IT)

(21) Appl. No.: 13/468,629

(22) Filed: May 10, 2012

Related U.S. Application Data
(63) Continuation-in-part of application No. 11/665,053, filed on Apr. 11, 2007.

(30) Foreign Application Priority Data
Nov. 3, 2004 (IT) BO2004A000680

(51) Int. Cl. B65G 27/04; B03C 1/02

(52) U.S. Cl. 209/223.1; 198/752.1

(57) ABSTRACT

A device (1) for feeding a product, in particular an infusion product, to a packaging machine is of the type comprising means (2, 6) for collecting and transporting the product and means (8) for conveying the product itself. The conveying means (8) are of the type with vibrating channeling means and are connected to the collection means (2, 6) to receive the product from the collection means (2, 6) and to feed the product to an operating station (10) of the packaging machine.

### TECHNICAL FIELD

This invention relates to a device for feeding a product to a packaging machine. In particular, this invention can be advantageously used for feeding an infusion product such as tea, coffee, chamomile, herbs or the like to an automatic packaging machine for making infusion packets, which the present specification expressly refers to but without restricting the scope of the invention.

### BACKGROUND ART

Usually, an automatic machine for making infusion packets such as filter bags, sachets, filter-paper pods, etc. comprises a plurality of stations located one after the other along a production line forming part of the automatic machine itself, and including, in particular, a feed station for placing measured quantities of infusion product on a web of filter material used to make the packets.

The feed station as a whole is in turn of known type and is defined by an upright tubular duct, into the open, funnel-shaped top end of which the infusion product is placed, and whose bottom end is connected with conveyor means designed to receive the infusion product from the tubular duct and to feed it to the hopper of a metering device which places measured quantities of the product on a web of filter paper.

At present, the conveyor means most widely used for applications of this kind can be divided broadly into the following two types: a first type, described for example in U.S. Pat. No. 4,628,973, comprises a rotary drum consisting basically of a hollow frustoconical body. The flared top end of the frustoconical body receives the bottom end of the aforementioned tubular duct, whilst the bottom end of the frustoconical body is partly inserted into the hopper of the metering device.

Feed stations equipped with rotary drums of this kind are very effective for feeding the infusion product and have for many years been the most widely used. These feed stations have inherent operating limits, however, particularly at the high speeds at which modern packaging machines now normally operate.

A second type of conveyor means, described for example in European patent application No. EP 1.340.669 A2, comprises an endless conveyor belt trained around a pair of pulleys, mounted under the upright tubular duct and leading into the hopper of the metering device, preferably at an angle to the hopper itself.

This solution has considerable disadvantages, due in particular to the powdery nature of the infusion product fed to the metering device hopper.

Indeed, the infusion product particles tend to adhere to the conveyor pulleys, causing them to jam and eventually leading to conveyor failure and prolonged down time.

Moreover, cleaning the conveyor and conveyor pulleys to remove infusion product particles and dust may be a difficult and laborious task, often requiring the conveyor drive mechanisms and components to be completely dismantled.

The aim of this invention is to provide an infusion product feeding device that overcomes the disadvantages of the prior art described above.

In particular, it is an aim of the present invention to provide feed device that is at once simple and efficient and that is capable of feeding the infusion product to a packaging machine that operates at high production speeds.

### DISCLOSURE OF THE INVENTION

This invention accordingly provides a device for feeding a product, in particular an infusion product, to a packaging machine, the device being of the type comprising means for collecting and transporting the product and means for conveying the product itself, the conveying means being connected to the collection means to receive the product from the collection means and to feed the product to an operating station of the packaging machine, the device being characterised in that the conveying means comprise vibrating channeling means.

### BRIEF DESCRIPTION OF THE DRAWINGS

The technical characteristics of the invention, with reference to the above aims, are clearly described in the claims below and its advantages are apparent from the detailed description which follows, with reference to the accompanying drawings which illustrate a preferred, non restricting embodiment of the invention provided merely by way of example, and which:

FIG. 1 shows a feeding device according to the invention in a schematic front view;

FIG. 2 shows the feeding device of FIG. 1 in a schematic perspective view;

FIGS. 3 and 4 are details from FIG. 1 and illustrate manual adjustment means in a closed configuration and in an open configuration, the figures being schematic front views;

FIG. 5 shows a detail from FIG. 1 in a lateral front view.

### DETAILED DESCRIPTION OF THE PREFERRED EMBODIMENTS OF THE INVENTION

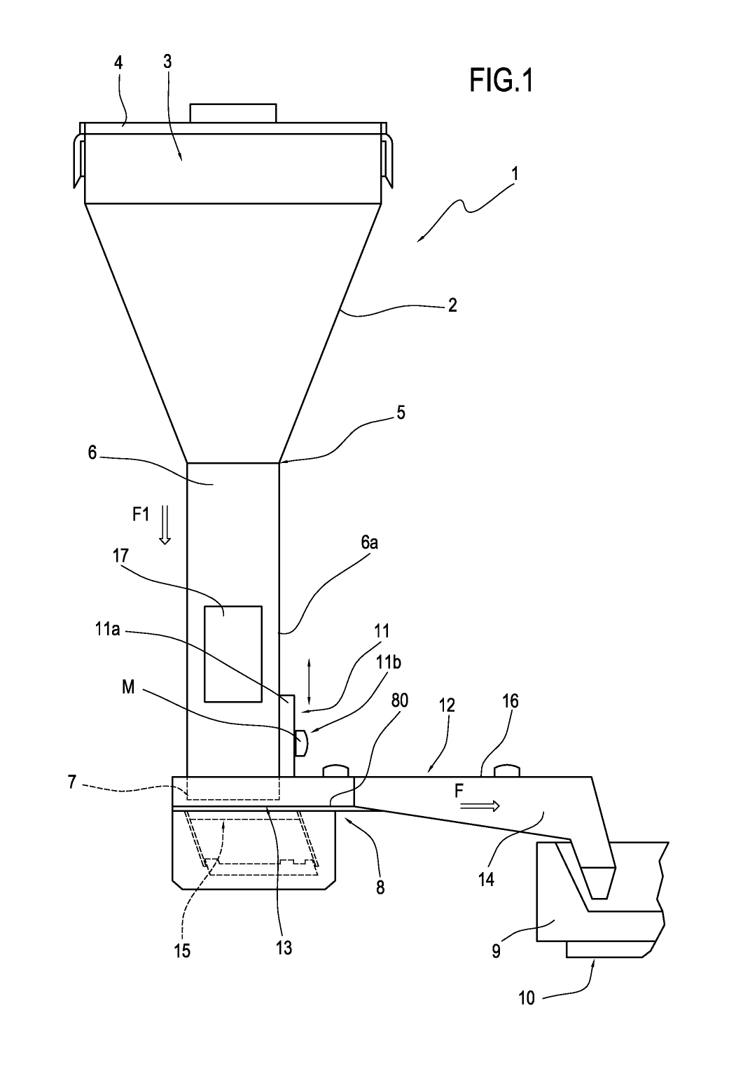

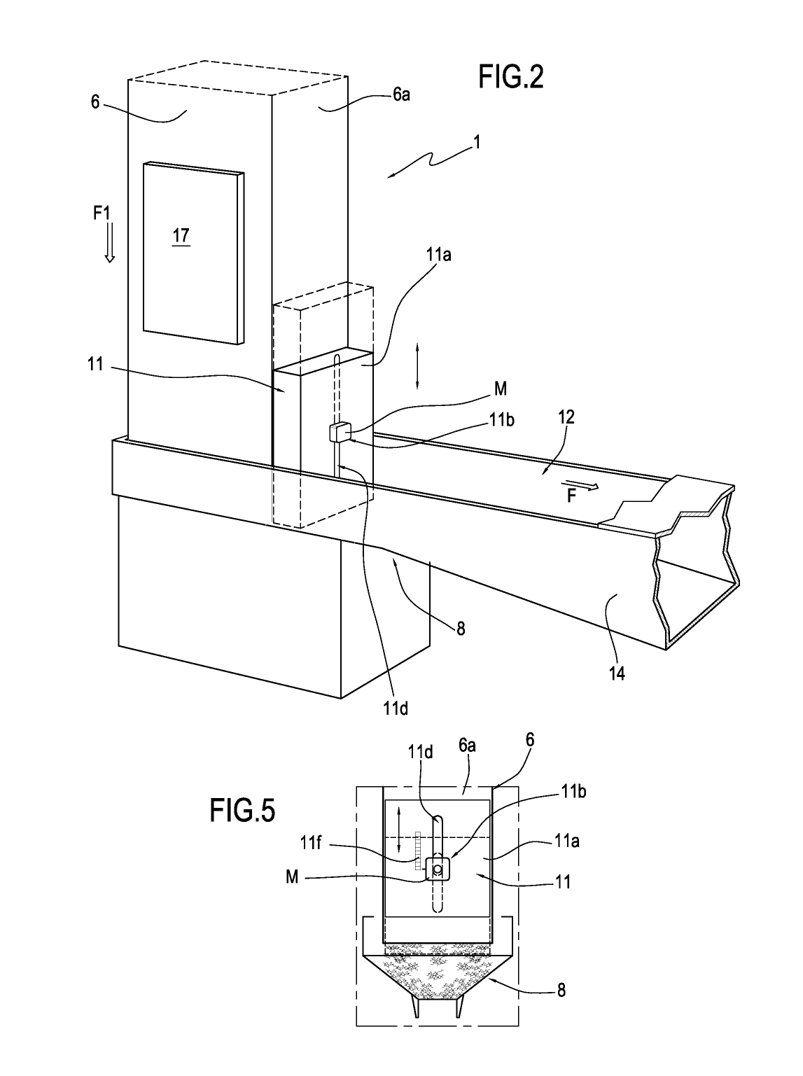

With reference to the accompanying drawings (in particular FIGS. 1 and 2), the numeral 1 denotes in its entirety, a feeding device used for feeding an infusion product (tea, coffee, chamomile, etc.) to an automatic packaging machine (of known type and therefore not illustrated) which is designed to make packets (also of known type and not illustrated). More specifically, the device 1 forms an integral part of an operating feed station of the packaging machine itself.

As illustrated in the accompanying drawings, the device 1 comprises a substantially funnel-shaped container 2 having a flared open top end 3 which is fitted with a lid 4 and into which the infusion product is placed, and a bottom end 5 which is connected or coupled to a hollow vertical tubular element 6.

The container 2 and the vertical tubular element 6 are two distinct elements which are coupled to each other.

The bottom end 7 of the tubular element 6 ends at and gives onto conveying means 8 which are designed to receive the infusion product falling out of the container 2 through the tubular element 6 itself and to feed it (arrow F) to a hopper 9 of a customary metering device 10 forming part of the operating feed station of the packaging machine.

In light of this, the product feed flow falls from the container 2 in a vertical direction F1 (along the tubular element 6). Next, the product flow follows the feed direction F imparted to it by the conveying means 8.

The direction F is transversal to the product falling direction F1.

It should be noted that at least in the first stretch of it, corresponding to the conveying means 8, the direction F is perpendicular to the falling direction F1.

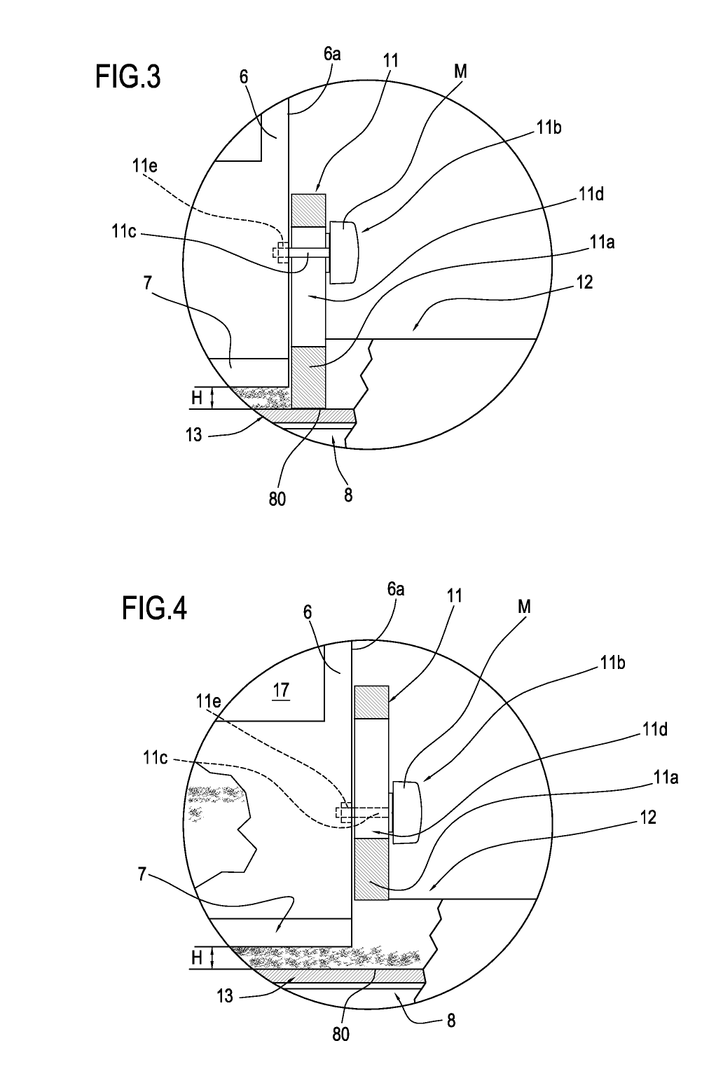

More specifically (see FIGS. 3, 4, 5), the edge of the bottom end 7 of the tubular element 6 and the conveying means 8 are spaced from each other to create an opening H defining the maximum quantity of product that can be fed along the selfsame conveying means 8.

In light of this, the tubular element 6 is equipped with manual adjustment means 11 configured to adjust the height of the opening H, in such a way as to control the quantity of infusion product which is fed along the conveying means 8.

With reference to the accompanying drawings, the conveying means 8 comprise a substantially tube-shaped duct 12, a first portion 13 of which is located under the end 7 of the tubular element 6 and a second portion 14 of which is tilted towards the hopper 9 and leads into the hopper 9 itself.

In light of this, the duct 12, or at least its first portion 13, extends transversely (that is, perpendicularly) to the duct 6.

More specifically, the duct 12 comprises a horizontal conveying surface 80 which defines the first portion 13 (and at least part of the second portion 14).

The duct 12, in particular at its first portion 13, is supported by and coupled with vibrating actuating means 15 designed to impart to the duct 12 a vibrating motion of defined amplitude in order to feed the infusion product on the duct 12 itself quickly towards the hopper 9 of the metering device 10.

At the top of it, the duct 12 is preferably equipped with opening/closing elements 16 providing easy access to the inside of the duct 12 for maintenance purposes so as to enable cleaning to be carried out quickly and easily.

Preferably, the opening H is defined between the edge of the bottom end 7 of the tubular duct 6 and the horizontal surface 80 of the first portion 13. In light of this, the manual adjustment means 11 adjust the quantity of product passing through the opening H coming from the initial stretch of the first portion 13 where the vibrating means 15 operate.

Positioned and operating on the tubular element 6 there are permanent magnet means 17 for retaining any metal particles that may be present in the infusion product, thereby preventing such metal particles from advancing along the element 6 and reaching the hopper 9.

During use, the metal particles retained by the means 17 can be removed by staff responsible for the maintenance of the packaging machine.

Preferably, (see FIGS. 3, 4, 5) the manual adjustment means 11 are slidably connected to one side 6a of the tubular element 6.

More specifically, the means 11 are located on the side 6a of the tubular element 6 facing towards the tube-shaped duct 12 of the conveying means 8 (on a side adjacent the side where the permanent magnet means 17 are located).

Preferably, the means 11 comprise a panel 11a which is movable between two or more positions (one of these being illustrated in FIG. 5) included between a first operating end position of minimum height of the opening H (FIG. 3) for closing the opening and a second operating end position of maximum height for allowing the maximum volume of infusion product to flow through the opening H (FIG. 4).

The panel 11a is in the closed position when its bottom end is in contact with the horizontal surface 80.

The panel 11a comprises an element 11b for stabilizing the position adopted by the panel 11a.

More specifically, the element 11b comprises a pin 11c which passes through a vertical slot 11d and which is constrained to the wall 6a of the tubular element 6 (by means of a lock nut 11e).

The pin 11c is equipped with a handgrip M for loosening the pin and allowing the panel 11a to slide vertically, thanks to the presence of the slot 11d. When the panel 11a is in the required position, the handgrip M can be used to tighten the pin 11c in such a way as to lock the panel 11a in the new position.

It should be noted that the panel 11a also comprises a numeric reference system with a graduated scale 11f located next to the slot 11d for displaying the movements of the panel 11a which has as fixed reference the handgrip M.

In use, therefore, the quantity of infusion product which falls on the conveying means 8 can subsequently be adjusted as it feeds along the direction F by adjusting the position of the vertical panel 11a relative to the horizontal surface 80.

The invention described can be modified and adapted in several ways without thereby departing from the scope of the inventive concept. Moreover, all the details of the invention may be substituted for technically equivalent elements.

1. A device for feeding a product, in particular an infusion product, to a packaging machine, being of the type comprising means for collecting and transporting the product and means for conveying said product, the conveying means being connected to the collection means to receive the product from the collection means and to feed the product to an operating station of the packaging machine, wherein the conveying means comprise vibrating channeling means.

2. The device according to claim 1, wherein the tubular element comprises a bottom end located above the conveying means; an edge of the bottom end and the conveying means being spaced from each other to create an opening whose height determines a maximum quantity of product which can be fed along the conveying means.

3. The device according to claim 1, wherein the tubular element is equipped with manual adjustment means configured to adjust the height of an opening, in such a way as to control the quantity of infusion product which is fed along the conveying means.

4. The device according to claim 2, wherein the manual adjustment means are slidably connected to one side of the tubular element.

5. The device according to claim 1, wherein the channeling means comprise a substantially tube-shaped duct, at least one portion of the duct being connected to actuating means designed to impart to the duct itself a vibrating motion of defined amplitude.

6. The device according to claim 5, wherein the channeling means comprise a horizontal surface which receives the product falling from a bottom end of a tubular element.

7. The device according to claim 1, characterised in that the channeling means are equipped, at the top of them, with opening/closing elements providing access to the inside of the channeling means themselves.

8. The device according claim 1, wherein the means for collecting and transporting the infusion product are coupled with permanent magnet means for retaining any metal particles that may be present in the infusion product.

9. The device according to claim 2, wherein the means 11 comprise a panel 11a which is movable between two or more positions included between a first operating end position of minimum height of the opening defined by the edge of the bottom end of the tubular channel for closing the opening and a second operating end position of maximum height for allowing the maximum volume of infusion product to flow through the opening.

10. The device according claim 9, wherein the panel is in the closed position when its bottom end is in contact with a horizontal surface defining a second portion 13 of a tube-shaped duct.

11. The device according to claim 9, wherein the panel 11a comprises an element for stabilizing the position adopted by the panel and acting between the panel and a surface of the tubular element.
